(19) United States
(12) Patent Application Publication
(10) Pub. No.: US 2001/0027064 A1
(43) Pub. Date: Oct. 4, 2001

(54) Power connector for DC microwave oven

(76) Inventors: Yong-Woon Han, Kunpo-city (KR); Seong-Deog Jang, Suwon-city (KR); Kwang-Seok Kang, Suwon-city (KR); Dae-Sung Han, Hwasung-kun (KR); Jin-Ho Kim, Suwon-city (KR); Han-Seong Yoo, Yongin-city (KR); Han-Sung Kang, Suwon-city (KR)

Correspondence Address: ROBERT E. BUSHNELL, 1522 K STREET NW, SUITE 300, WASHINGTON, DC, 200051202

(21) Appl. No.: 09/756,238

(22) Filed: Jan. 9, 2001

(30) Foreign Application Priority Data
Mar. 31, 2000 (KR) 17038/2000

(51) Int. Cl. H01R 13/502

(52) U.S. Cl. 439/687

(57) ABSTRACT

Disclosed is a power connector for a DC microwave oven, suitable for connecting power cords which are led from a DC power source and have positive and negative polarities, respectively, to a component arranged in a device chamber which is defined in a body of the DC microwave oven. The power connector comprises a connector body fixedly secured to a rear plate of the body of the DC microwave oven; power terminals for positive and negative polarities, the power terminals projecting into the device chamber from a rear surface of the connector body; and power cord connecting means projecting from a front surface of the connector body, for enabling the power cords which are led from the DC power source and have positive and negative polarities, to be connected thereto, respectively.

### CLAIM OF PRIORITY

This application makes reference to, incorporates the same herein, and claims all benefits accruing under 35 U.S.C. §119 from my application POWER CONNECTOR OF A DC MICROWAVE OVEN filed with the Korean Industrial Property Office on Mar. 31, 2000 and there duly assigned Ser. No. 17038/2000.

### BACKGROUND OF THE INVENTION

1. Field of the Invention

The present invention relates to a DC microwave oven, and more particularly, to a power connector for a DC microwave oven, which enables DC power cords having applied thereto a high current to be connected to a component inside the DC microwave oven in such a way as to accomplish maximum surface contact, thereby improving connectability of the power cords and minimizing power loss through the power cords.

2. Description of the Related Art

Generally, in a microwave oven, AC power which is supplied from a utility AC power source, is transformed into a high voltage and then, is used to drive a magnetron. Microwaves which are produced in the magnetron and have a high frequency, are radiated toward a food, and the food is cooked by heat which is generated by radiation of the microwaves.

In such an AC microwave oven, there is defined a device chamber. A high voltage transformer for driving the magnetron and a magnetron driving circuit which comprises a plurality of micro-switches for controlling an operation of the high voltage transformer, are disposed in the device chamber of the AC microwave oven. The high voltage transformer and the magnetron driving circuit operate by receiving utility AC power from the outside through a power connector.

Due to the fact that the power connector for the AC microwave oven is configured so as to receive a low current in view of AC power of 100V or 220V, power cords are not so thick that terminal connection works of the power cords can be implemented in a convenient manner.

On the other hand, recently, a DC microwave oven which uses DC power, has been disclosed in the art to allow a user to conveniently cook a food in mobile means such as a motor vehicle or in an outdoor field. In order to receive from a DC power source such as a battery DC voltage which is used in such a DC microwave oven, power cords each of which has a cross-sectional area of no less than 22 mm 2, must be used and connected to the DC power source such as a battery, so as to stand a high current of 80 A to 100 A in a sufficient manner.

However, on the contrary to the fact that, in the DC microwave oven, bare wires of the power cords which are connected to the DC power source and have the cross-sectional area of no less than 22 mm 2, should be connected to the DC microwave oven with sufficient surface contact, because a power connector for connecting the thick power cords with sufficient surface contact is not disclosed in the art at the present stage, connectability of the power cords which are led from the DC power source, is deteriorated, whereby power loss is increased and a dangerous situation can occur in the course of using the DC microwave oven.

As a consequence, there is raised a demand for a novel power connector which connects thick power cords led from a DC power source to a DC microwave oven with sufficient surface contact, thereby decreasing power loss and preventing a dangerous situation from occurring.

### SUMMARY OF THE INVENTION

Accordingly, the present invention has been made in an effort to solve the problems occurring in the related art, and an object of the present invention is to provide a power connector for a DC microwave oven, which enables power cords led from a DC power source having applied thereto a high current to be connected to a component inside the DC microwave oven in such a way as to accomplish maximum surface contact, thereby improving connectability of the power cords and minimizing power loss through the power cords.

In order to achieve the above object, according to the present invention, there is provided a power connector for a DC microwave oven, suitable for connecting power cords which are led from a DC power source and have positive and negative polarities, respectively, to a component arranged in a device chamber which is defined in a body of the DC microwave oven, the power connector comprising: a connector body fixedly secured to a rear plate of the body of the DC microwave oven; power terminals for positive and negative polarities, the power terminals projecting into the device chamber from a rear surface of the connector body; and power cord connecting means projecting from a front surface of the connector body, for enabling the power cords which are led from the DC power source and have positive and negative polarities, to be connected thereto, respectively.

By the features of the present invention, in the case that AWG4 power cords which are led from a DC power source such as a battery and each of which has a cross-sectional area of 22 mm 2, are connected to a component which is arranged in a device chamber of a DC microwave oven, it is possible to realize a power connector which accomplishes maximum surface contact and reliable connection of the power cords each having a substantial thickness, whereby connectability of the power cords is improved and power loss through the power cords is minimized.

### BRIEF DESCRIPTION OF THE DRAWINGS

The above objects, and other features and advantages of the present invention will become more apparent after a reading of the following detailed description when taken in conjunction with the drawings, in which:

FIG. 1 is an exploded perspective view illustrating an entire construction of a power connector for a DC microwave oven in accordance with an embodiment of the present invention;

FIG. 2 is a front view illustrating an inner connection pattern of the power connector of FIG. 1;

FIG. 3 is a perspective view illustrating a state wherein a power cord is connected to the power connector according to the present invention;

FIG. 4 is a perspective view illustrating an example in which the power connector according to the present invention is attached to the DC microwave oven; and

FIG. 5 is a cross-sectional view illustrating a state wherein a power connector is connected to the microwave oven according to the present invention.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

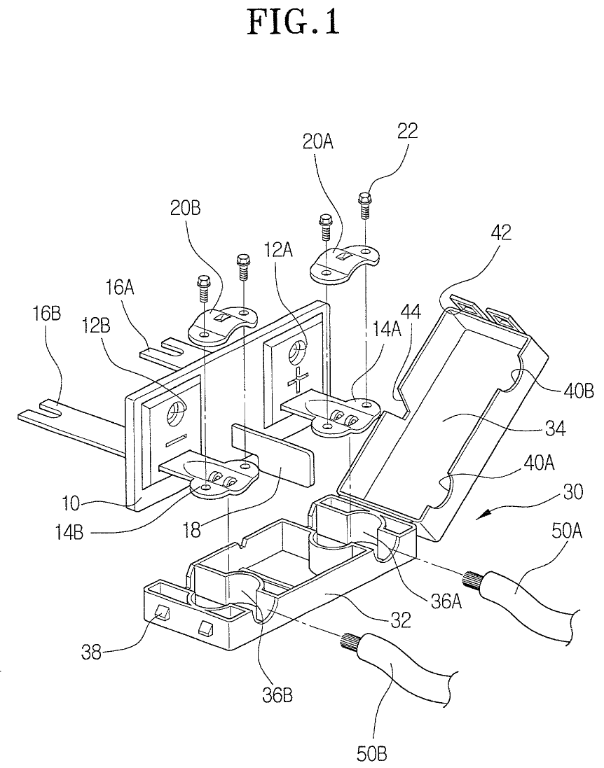

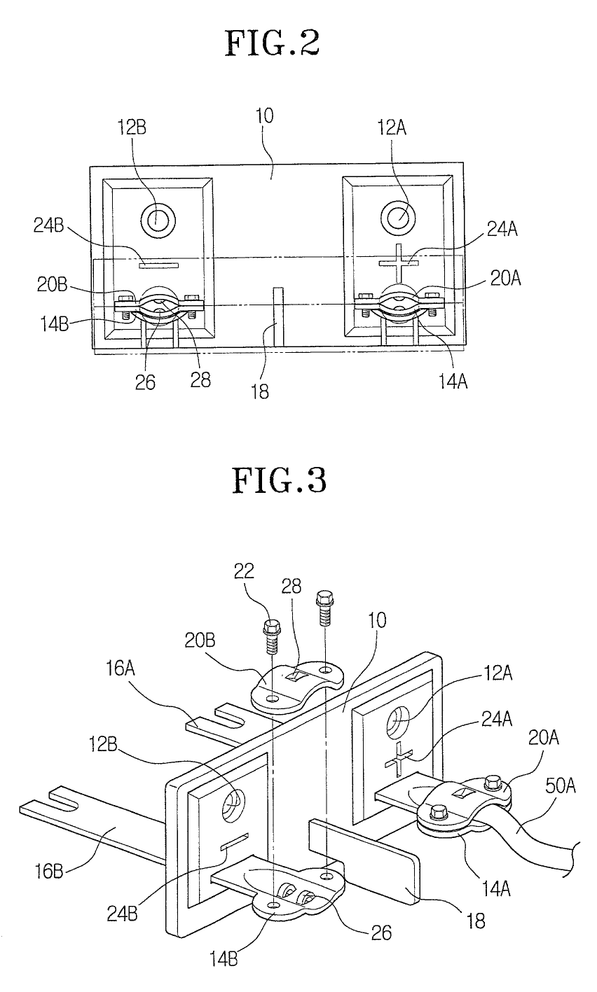

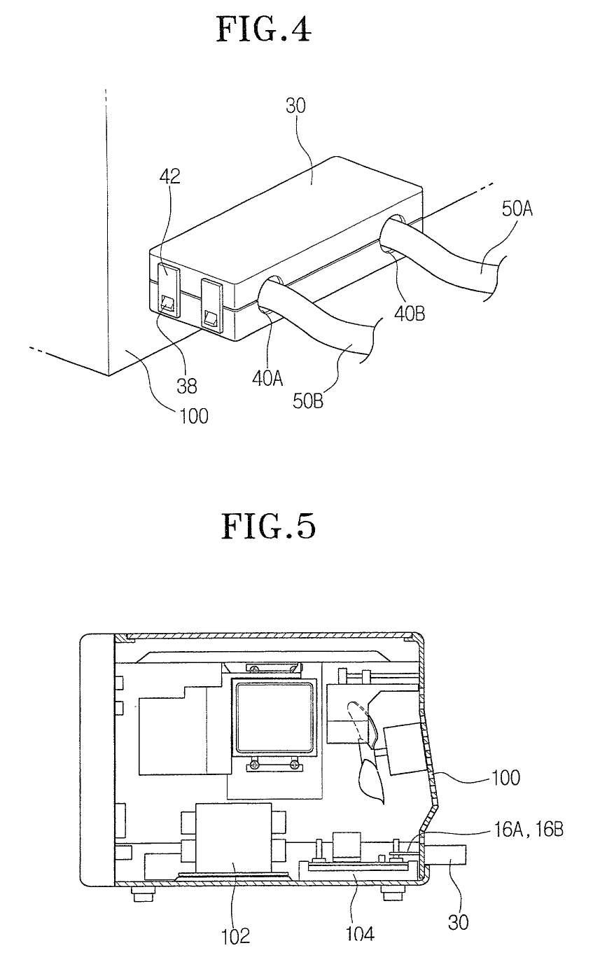

FIG. 1 is an exploded perspective view illustrating an entire construction of a power connector for a DC microwave oven in accordance with an embodiment of the present invention; FIG. 2 is a front view illustrating an inner connection pattern of the power connector of FIG. 1; FIG. 3 is a perspective view illustrating a state wherein a power cord is connected to the power connector according to the present invention; and FIG. 4 is a perspective view illustrating an example in which the power connector according to the present invention is attached to the DC microwave oven.

As shown in FIGS. 1 through 4, a power connector for a DC microwave oven according to the present invention includes a connector body 10. Threaded holes 12A and 12B are defined through the connector body 10. The connector body 10 is mounted at a predetermined location to a rear end of the DC microwave oven by means of screws which are threaded through the threaded holes 12A and 12B. Two wire connecting sections 14A and 14B project from a front surface, to enable bare wires of two power cords 50A and 50B which respectively have positive polarity and negative polarity and are led from a DC power source such as a battery, to be respectively connected thereto.

The two wire connecting sections 14A and 14B are integrally formed through the connector body 10 with two power terminals 16A and 16B, respectively, which project from a rear surface of the connector body 10 to be led into a device chamber which is defined in the DC microwave oven.

The wire connecting section 14A is used for enabling the bare wire of the power cord 50A which has positive polarity, to be connected thereto, and the wire connecting section 14B is used for enabling the bare wire of the power cord 50B which has negative polarity, to be connected thereto.

Also, a terminal isolating plate 18, which is made of a non-conductive material, for example, synthetic resin such as plastic, is integrally formed with the connector body 10 in a manner such that the terminal isolating plate 18 is interposed between the two wire connecting sections 14A and 14B respectively used for positive polarity and negative polarity and projects from the front surface of the connector body 10 in a direction perpendicular to a plane of the connector body 10. The terminal isolating plate 18 functions to prevent electrical short from occurring due to the fact that the bare wires of the power cords 50A and 50B are connected to the wire connecting section 14A for positive polarity and the wire connecting section 14B for negative polarity, respectively.

Two connecting covers 20A and 20B are respectively locked onto the two wire connecting sections 14A and 14B for positive and negative polarities by means of screws 22 in a manner such that the bare wires of the power cords 50A and 50B are sandwiched therebetween, respectively. The two wire connecting sections 14A and 14B and the two connecting covers 20A and 20B are formed with rounded portions, respectively, to maximize surface contact when the bare wires of the power cords 50A and 50B each having a substantial thickness are connected therebetween.

Further, as shown in FIGS. 2 and 3, first connecting protrusions 26 are formed on inner surfaces of the rounded portions of the wire connecting sections 14A and 14B for positive and negative polarities, to improve connectability of the wire connecting sections 14A and 14B with the bare wires of the power cords 50A and 50B for positive and negative polarities. And, second connecting protrusions 28 are formed on inner surfaces of the rounded portions of the connecting covers 20A and 20B, to improve connectability of the connecting covers 20A and 20B with the bare wires of the power cords 50A and 50B.

Here, the first connecting protrusions 26 which are provided to the wire connecting sections 14A and 14B and the second connecting protrusions 28 which are provided to the connecting covers 20A and 20B, are formed in a manner such that they are alternately positioned when the connecting covers 20A and 20B are locked onto the wire connecting sections 14A and 14B, respectively.

In the meanwhile, between places in which the wire connecting sections 14A and 14B for positive and negative polarities are located on the front surface of the connector body 10 and places in which the threaded holes 12A and 12B are defined in the connector body 10, polarity indicating sections 24A and 24B for indicating positive and negative polarities, respectively, are formed, by an engraving technique, on the front surface of the connector body 10. By this, symbols which correspond to the positive and negative polarities, respectively, are formed on the front surface of the connector body 10.

In order to allow polarities at the connection places to be easily discerned when the power codes 50A and 50B having positive and negative polarities are connected to the wire connecting sections 14A and 14B, respectively, paints which have different colors, are coated on the polarity indicating sections 24A and 24B, respectively. In other words, for example, a red paint is coated, on the polarity indicating section 24A for positive polarity, and a black paint is coated on the polarity indicating section 24B for negative polarity.

Moreover, an outer case 30 for closing a power cord connection region which is defined in front of the connector body 10, is installed on the front surface of the connector body 10 which supports the two wire connecting sections 14A and 14B. The outer case 30 comprises a case body 32 which has substantially a rectangular receptacle-shaped configuration for closing one half of the power cord connection region and a case cover 34 which is seated on the case body 32 for closing the other half of the power cord connection region. The case body 32 and the case cover 34 are made of a non-conductive resinous material and integrally connected with each other.

The case body 32 of the outer case 30 is defined with a receiving groove 36A for positive polarity and a receiving groove 36B for negative polarity, which have the same cross-sectional shape as the wire connecting sections 14A and 14B. The wire connecting section 14A for positive polarity and the wire connecting section 14B for negative polarity are received in the receiving grooves 36A and 36B, respectively, in a state wherein they are electrically isolated from each other. Locking projections 38 are formed on outer surfaces of both side walls of the case body 32, and locking holes 42 are defined in outer surfaces of both side walls of the case cover 34, in a manner such that the locking projections 38 of the case body 32 can be locked into the locking holes 42 of the case cover 34, respectively.

In the meantime, a front wall of the case body 32 and a front wall of the case cover 34 cooperatively define introducing holes 40A and 40B for allowing the power cords 50A and 50B for positive and negative polarities to respectively pass therethrough toward the connector body 10. Each of rear walls of the case body 32 and the case cover 34 is formed with a depression 44 for accommodating therein the terminal isolating plate 18. As described above, the locking holes 42 are defined in outer surfaces of both side walls of the case cover 34, in a manner such that the locking projections 38 of the case body 32 can be locked into the locking holes 42 of the case cover 34, respectively.

In the power connector according to the present invention, constructed as mentioned above, the connector body 10 is mounted to a rear plate 100 of the DC microwave oven by means of the screws which are threaded through the threaded holes 12A and 12B. As shown in FIG. 5, the power terminals 16A and 16B for positive and negative polarities, which project from the rear surface of the connector body 10, are respectively connected to a printed circuit board 104 which is disposed in the device chamber defined in the DC microwave oven and has an inverter circuit for inverting a DC voltage into an AC voltage in order to supply the AC voltage to a high voltage transformer 102.

In this state, the bare wires of the power cords 50A and 50B for positive and negative polarities, which are led from the DC power source such as the battery, are respectively connected to the wire connecting sections 14A and 14B for positive and negative polarities, which project from the front surface of the connector body 10.

Thereupon, the two connecting covers 20A and 20B are locked onto the two wire connecting sections 14A and 14B, respectively, by means of screws 22. At this time, the bare wires of the power cords 50A and 50B which are connected to the wire connecting sections 14A and 14B and the connecting covers 20A and 20B, are tightly squeezed by the first connecting protrusions 26 which are formed on the inner surfaces of the rounded portions of the wire connecting sections 14A and 14B and the second connecting protrusions 28 which are formed on the inner surfaces of the rounded portions of the connecting covers 20A and 20B, whereby connectability of the power cords 50A and 50B is improved and reliable connection of the power cords 50A and 50B is ensured.

On the other hand, if the bare wires of the power cords 50A and 50B are connected to the wire connecting sections 14A and 14B and the connecting covers 20A and 20B, respectively, the front surface of the connector body 10 is closed by the outer case 30.

That is to say, after connection parts of the power cords 50A and 50B with the wire connecting sections 14A and 14B and the connecting covers 20A and 20B are respectively received in the receiving grooves 36A and 36B which are defined in the case body 32 of the outer case 30, at as shown in FIG. 4, the locking projections 38 of the case body 32 are respectively locked into the locking holes 42 of the case cover 34, whereby it is possible to prevent foreign substances or moisture from the outside contaminating the bare wires of the power cords 50A and 50B or the wire connecting sections 14A and 14B.

As a result, by the present invention, advantages are provided in that, since a power connector for reliably connecting, with maximum surface contact, power cords which are led from a DC power source having generated therefrom a high current and each of which has a substantial thickness, is realized, connectability of the power cords is improved and power loss through the power cords is minimized.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A power connector for a DC microwave oven, suitable for connecting power cords which are led from a DC power source and have positive and negative polarities, respectively, to a component arranged in a device chamber which is defined in a body of the DC microwave oven, the power connector comprising:
a connector body fixedly secured to a rear plate of the body of the DC microwave oven;
power terminals for positive and negative polarities, the power terminals projecting into the device chamber from a rear surface of the connector body; and
power cord connecting means projecting from a front surface of the connector body, for enabling the power cords which are led from the DC power source and have positive and negative polarities, to be connected thereto, respectively.

2. The power connector as claimed in claim 1, wherein the power cord connecting means comprise wire connecting sections for positive and negative polarities, each of which has a first rounded portion, and connecting covers for positive and negative polarities, which are respectively coupled to the wire connecting sections by means of screws and each of which has a second rounded portion.

3. The power connector as claimed in claim 2, wherein first and second protrusions are respectively formed on the first and second rounded portions of the wire connecting sections and the connecting covers, in a manner such that the first and second protrusions are protruded toward each other.

4. The power connector as claimed in claim 2, wherein polarity indicating sections for indicating positive and negative polarities, respectively, are formed, by engraving, on the front surface of the connector body above places where the wire connecting sections for positive and negative polarities are located on the front surface of the connector body.

5. The power connector as claimed in claim 4, wherein the polarity indicating sections for positive and negative polarities are respectively coated with paints which have different colors.

6. The power connector as claimed in claim 2, wherein a terminal isolating plate is interposed between the wire connection sections for positive and negative polarities in a manner such that the terminal isolating plate integrally projects from the connector body.

7. The power connector as claimed in claim 1, wherein the power cord connecting means further comprise outer case means for closing a power cord connection region which is defined in front of the connector body.

8. The power connector as claimed in claim 7, wherein the outer case means comprises a case body which has substantially a rectangular receptacle-shaped configuration for closing one half of the power cord connection region and a case cover which is seated on the case body for closing the other half of the power cord connection region.

9. The power connector as claimed in claim 8, wherein the case body is defined with receiving grooves for positive and negative polarities, which have the same cross-sectional shape as the power cord connecting means, so as to allow the power cord connecting means for positive and negative polarities to be received therein, respectively, in a state in which the power cord connecting means are electrically isolated from each other; and the case body and the case cover cooperatively define introducing holes for allowing the power cords for positive and negative polarities to respectively pass therethrough toward the connector body.

10. The power connector as claimed in claim 8, wherein locking projections are formed on outer surfaces of both side walls of the case body, and locking holes are defined on outer surfaces of both side walls of the case cover, in a manner such that the locking projections of the case body can be locked into the locking holes of the case cover, respectively.

11. The power connector as claimed in claim 8, wherein the case body and the case cover are made of a non-conductive resinous material and integrated with each other.
